(19) United States
(12) Patent Application Publication
(10) Pub. No.: US 2026/0233492 A1
(43) Pub. Date: Aug. 13, 2026

(54) METHOD OF PRODUCING A LAMINATED METAL SHEET FOR PACKAGING APPLICATIONS AND LAMINATED METAL SHEET FOR PACKAGING APPLICATIONS PRODUCED THEREBY

(71) Applicant: TATA STEEL IJMUIDEN B.V., Velsen-Noord (NL)

(72) Inventors: Dmitry KONDRATIUK, Haarlem (NL); Jan Paul PENNING, ‘s Gravenhage (NL)

(73) Assignee: TATA STEEL IJMUIDEN B.V., Velsen-Noord (NL)

(21) Appl. No.: 19/153,886

(22) PCT Filed: Mar. 6, 2024
(86) PCT No.: PCT/EP2024/055891

§ 371 Date: Aug. 5, 2025

(30) Foreign Application Priority Data
Mar. 8, 2023 (EP) 23160819.1

(51) Int. Cl. B32B 15/09; B32B 15/18; B32B 37/00; B32B 37/10; B32B 37/12; B32B 38/00; C25D 3/04

(52) U.S. Cl. CPC B32B 15/09; B32B 15/18; B32B 37/085; B32B 37/10; B32B 37/12; B32B 38/0012; B32B 38/0036; B32B 38/164; C25D 3/04; B32B 2038/0028; B32B 2250/04; B32B 2255/06; B32B 2255/205; B32B 2307/516; B32B 2311/30; B32B 2367/00; B32B 2439/66

(57) ABSTRACT

A method of producing a laminated metal sheet for packaging applications and laminated metal sheet for packaging applications produced thereby. The use of the laminated metal sheet for making a seamless container body by drawing from the laminated metal sheet.

### FIELD OF THE INVENTION

This invention relates to a method of producing a laminated metal sheet in a continuous coating line wherein the laminated metal sheet comprises a laminate layer comprising at least an adhesion layer (A) and a bulk layer (B) on at least one side of the metal sheet. The invention also relates to a laminated metal sheet for packaging applications and to laminated metal sheet for packaging applications produced by said method.

### BACKGROUND OF THE INVENTION

Laminated metal sheet for packaging applications comprises a metal sheet and a laminate layer that covers at least one side of the metal sheet. Such a laminated metal sheet is produced by laminating the laminate layer onto one or both sides of the metal sheet. A laminate layer may consist of one polymer layer, or it may consist of two or more individual coating layers stacked onto one another. The laminate layers may be identical in terms of composition, thickness or build-up, or they may be different. Also the laminate layers on either side of the metal sheet may differ in composition, thickness or build-up. A laminate layer is usually provided in the form of a thin film having a typical thickness of between 10 and 50 μm.

If the laminate layer at least partly comprises polyester, then the laminate layer is applied to the metal sheet by i). heat bonding the laminate layer to the metal sheet, or ii). by using an adhesion promoter between the laminate layer and the metal sheet, or iii). by using a laminate layer comprising an adhesion layer, or iv). a suitable combination thereof. The laminate layer may be produced in-line and laminated onto the metal sheet in an integrated lamination step, or a pre-produced laminate layer may be laminated onto the metal sheet in a separate lamination step

The way the laminate layer is produced, prior to laminating it onto the metal sheet, means that most if not all of it is produced by stretching a thick cast film into a thin laminate layer often followed by an annealing (“heat setting”) stage to avoid shrinkage of the laminate layer during the lamination onto the metal sheet. In most stretched laminate layers, the polymer molecules are either biaxially oriented or uniaxially oriented, depending on whether the film was biaxially stretched or uniaxially stretched during its production.

The most commonly used laminate layer is biaxially stretched (or biaxially oriented (BO)) where the laminate layers have substantially the same degree of orientation in a first direction and in a direction perpendicular to the first direction. The BO laminate layers are stretched in the machine direction (MD) and in the transverse direction (TD) to substantially the same degree. Examples of BO-laminate layers based on semi-crystalline polyesters such as polyethylene terephthalate (PET) and polybutylene terephthalate (PBT) and their blends laminated on steel substrates are disclosed in EP0312304.

An alternative type of stretching of a laminate layer is uniaxial stretching as disclosed in U.S. Pat. No. 9,346,254. A metal substrate is provided on one or both sides with a machine direction oriented (MDO) laminate layer. Without heat setting this uniaxial stretching results in laminate layers which retain a strong orientation of the polymer chains in the direction of stretching. The laminate layer may also be uniaxially stretched in the transverse direction (TDO) leading to a strong orientation of the polymer chains in the transverse direction. In both the MDO and the TDO laminate layers the properties of the laminate layer in both in-plane directions (MD and TD) are different.

Heat bonding of the laminate layer onto a heated metal sheet reduces or eliminates the residual orientation through re-melting of laminate layer, at least at the surface of the metal substrate. Normally the laminated metal sheet is subjected to a heat treatment, commonly referred to as “post-heat” wherein the post-heat set-point temperature exceeds the melting point of the polymer in the laminate layers with the highest melting point. After the post-heat step the laminated metal sheet is rapidly cooled, e.g. by quenching the laminated metal sheet in a water tank or by means of water spray or mist or a combination thereof. It is noted that the lamination step is usually performed on a metal sheet or a metal strip, wherein the latter is usually supplied in a coiled form which allows a continuous lamination process. In the context of this invention metal strip shall also be considered a metal sheet, albeit a very long one.

The laminated metal sheet is often used for the production of deep-drawn can bodies or for drawn and wall ironed (DWI) can bodies or can ends. During these forming processes the laminated metal sheet is subjected to quite severe deformations. Also the can bodies or can ends may be subjected to subsequent heat treatments after forming, e.g. during varnish curing or printing operations. This may cause problems with adhesion of the laminate layer to the metal sheet or bad barrier properties and poor corrosion resistance due to formation of microcracks (crazing), loss of polymer coating adhesion (in case of can bodies and ends) or during can opening process (coating feathering) in case of ends.

### OBJECTIVES OF THE INVENTION

It is an object of this invention to provide a laminated metal sheet with a good adhesion of the laminate layer to the metal sheet, with good barrier properties and good corrosion resistance.

It also an object to provide a method for producing a laminated metal sheet with a good adhesion of the laminate layer to the metal sheet, with good barrier properties and good corrosion resistance.

It is also an object to provide a method for controlling the quality of the process for producing a laminated metal sheet with a good adhesion of the laminate layer to the metal sheet, with good barrier properties and good corrosion resistance.

### DESCRIPTION OF THE INVENTION

In a first aspect of the invention the object is reached by a method for producing a laminated metal sheet (9) in a continuous coating line operating at a line speed v, the laminated metal sheet (9) comprising a laminate layer (3), the method comprising the subsequent steps of:
a. providing a metal sheet (1);
b. providing a predominantly or solely uniaxially oriented laminate layer (3) for coating onto at least one side of the metal sheet, the laminate layer (3) comprising at least an adhesion layer (A) and a bulk layer (B) and optionally one or more additional top layers (TL) on top of the bulk layer, wherein the adhesion layer (A) is intended for bonding to the metal sheet and either i). contains or comprises a copolyester having 5-30 wt. % ethylene-isophthalate units, 70-95 wt. % ethylene-terephthalate units and 0-5 wt. % other components, or ii) contains or comprises 60-100 wt. % of a non-crystallisable copolyester, 0-40 wt. % of a crystallisable polyester or copolyester or a blend thereof such as (e.g.) polyethylene-terephthalate and 0-10 wt. % other components, and wherein the bulk layer (B) and the optional one or more additional top layers (TL) on top of the bulk layer consist essentially of poly(ethylene terephthalate) having at least 90% ethylene-terephthalate units, wherein the adhesion layer (A), the bulk layer (B) and the optional one or more additional top layers (TL) on top of the bulk layer each optionally contain(s) additives like slip additives and anti-block particles, and wherein the bulk layer optionally contains colouring agents, dyes, toners, or pigment particles;
c. pre-heating the metal sheet (1) to a pre-heat set-point temperature T1 wherein T1 is sufficiently high to provide initial adhesion to the laminate layer (3) but not so high as to melt the bulk layer (B) nor any of the optional additional top layers (TL) in the laminate layer (3);
d. laminating the laminate layer (3) onto the metal sheet (1) to produce a laminated metal sheet (9);
e. post-heating the laminated metal sheet (9) to a post-heat set-point temperature T2 without melting the bulk layer (B) nor any of the optionally present additional top layers (TL) in the laminate layer (3) and wherein T2 is sufficiently high to produce a value of D_{adh} in the range of 0 to 0.10 after cooling the post-heated laminated metal sheet (9);
f. cooling the post-heated laminated metal sheet (9), preferably to ambient temperature, to produce a laminated metal sheet (9) with a value for the Euclidean distance matrix D_{adh} of the adhesion layer (A) between a first and a second ATR FTIR spectrum of the adhesion layer (A) having a value in the range of 0 to 0.10, and a value for the Euclidean distance matrix D_{bulk} of the bulk layer (B) between a first and a second ATR FTIR spectrum of the bulk layer (B) having a value in the range of 0.10 or higher, and wherein the first ATR FTIR spectrum is measured in an ATR-FTIR spectrometer with the incident IR-beam in a first in-plane orientation to the machine direction of the laminated metal sheet or corresponding free-standing laminate layer and wherein the second ATR FTIR spectrum is measured in the ATR-FTIR spectrometer after rotating the laminated metal sheet or corresponding free-standing laminate layer over an angle alpha (x) in the plane of the laminate layer (3) selected between 70° and 110° to a second in-plane orientation, and wherein the ATR-FTIR spectra are measured in the spectral range which includes the range of 1160 to 1520 cm⁻¹.

In this method a predominantly or solely uniaxially oriented laminate layer is laminated onto at least one side of the metal sheet in a continuous process, the laminate layer comprising at least an adhesion layer (A) and a bulk layer (B), and optionally also one or more additional top layers (TL) on top of the bulk layer, each layer containing 50% by mass or more of polyester. The additional top layer may contain one or more layers and may be more or less identical to the bulk layer (B) in composition and/or thickness, or they may be identical in polymer composition but, either one may contain additives. For example, the additional top layer may contain slip additives and anti-block particles, and the bulk layer may contain colouring agents, dyes, toners or pigment particles. The adhesion layer (A) is intended for bonding to the metal sheet and contains or comprises a copolyester having 5-30 wt. % ethylene-isophthalate units, 70-95 wt. % ethylene-terephthalate units and 0-5 wt. % other components, or the adhesion layer contains or comprises 60-100 wt. % of a non-crystallisable copolyester, 0-40 wt. % of a crystallisable polyester or copolyester or a blend thereof such as (e.g.) polyethylene-terephthalate and 0-10 wt. % other components. The bulk layer (B) and any optional additional top layers (TL) consists essentially of poly(ethylene terephthalate) having at least 90 wt. % ethylene-terephthalate units. The adhesion layer and the bulk layer optionally contain(s) additives, such as slip additives and anti-block particles, and wherein the bulk layer optionally contains additives such as colouring agents, dyes, toners or pigment particles. Preferably the amount of additives in each of the adhesion layer and/or in the bulk layer is at most 5 wt. %, with the exception of colouring agents which may be present in the bulk layer up to about 20 wt. %.

In the context of this invention a method or product “comprising” certain features is to be interpreted as meaning that it includes those features, but that it does not exclude the presence of other features, as long as they do not render the claim unworkable. If the wording “consist of” is used, then no further features are present in the apparatus/method/product apart from the ones following said wording.

In order to improve the adhesion of the laminate layer to the metal sheet it is important that the adhesion layer has sufficient initial adhesion to adhere to the metal sheet during the continuation of the lamination process as the adhesion is not yet at its maximum at this stage. This initial adhesion is achieved by pre-heating the metal sheet to a pre-heat set-point T1 sufficiently high to provide initial adhesion to the laminate layer. For this to be the case T1 has to be above the glass transition temperature (Tg) of the polymer material in the adhesion layer. To retain the favourable properties of the bulk layer in the prelamination stage, and in particular the orientation of the polymer layer (MDO or TDO) it is important that during the prelamination stage and during the lamination T1 does not exceed the melting temperature of the bulk layer to retain most if not all of the bulk layer's orientation that it had before the pre-lamination steps. In the post-lamination stage the laminated metal sheet is heated to a post-heat set-point T2 that is sufficiently high to melt or soften the adhesion layer but without melting the bulk layer in the laminate layer and after cooling is sufficient to release stresses between the amorphous adhesion layer (A) and the still predominantly or solely uniaxially oriented laminate layer (B). After cooling, preferably to ambient temperature, the post-heated laminated metal sheet the molten adhesion layer solidifies and, as a result of its composition, stays fully or largely amorphous, which achieves the good adhesion properties of the adhesion layer to the metal sheet. The cooling rate therefore has to be sufficiently fast to prevent crystallisation of the adhesion layer. For some adhesion layers like a PETg (PolyEthylene Terephthalate glycol-modified) adhesion layer, which cannot crystallise, the cooling rate is not important, but from a productional consistency point of view it is preferably to use fast cooling by means of air, mist or water spraying or quenching into a water bath. The fast cooling does not affect PETg, which is non-crystallisable, but it does prevent the crystallisation of other types of adhesion layers like i-PET CA248 (see Table 1). From the experimental evidence it is clear that a post-heat to the T2 set-point is essential. If there is no post-heat, then on the one hand the adhesion force between the adhesion layer and the metal sheet is not sufficient, and on the other hand stresses develop between amorphous adhesion layer (A) and uniaxially oriented bulk layer (B) due to a different volume relaxation rates of amorphous adhesion layer and uniaxially oriented bulk layer (B) and the subsequent properties of the laminated metal sheet after quenching are unsatisfactory. T2 must be sufficiently high to achieve melting or at least softening of the adhesion layer. The bulk layer may not be melted, i.e. T2 stays below the melting temperature of the bulk layer polymer, so this layer retains most if not all of its orientation that it had before. The bulk properties are thereby also retained which results in a well adhering laminate layer to the metal sheet with a bulk layer having good barrier properties and corrosion resistance.

The degree of orientation of adhesion and bulk layers can be measured by determining an ATR-FTIR spectrum in two directions recorded on the external side of the corresponding layer as described in WO2021180651. Herein it is described how the orientation in the laminate layer or of the individual layers in the laminate layer laminated on metal sheet can be determined by comparing two ATR-FTIR spectra in a specific frequency range encompassing, but not necessarily limited to, the 1160 to 1520 cm-1 range measured in two different directions of a laminated metal sheet sample rotated over a set angle alpha with respect to the normal of the sample. Preferably the first spectrum is measured with the orientation in the machine direction and the second spectrum after a rotation of the sample over an angle selected between 70 to 110°. Alternatively, the first spectrum is measured with the orientation perpendicular to the machine direction, and the second spectrum after a rotation over an angle selected between 70 to 110°. The angle of rotation alpha between the two directions of the sample is preferably between 85° and 95°, and more preferably about 90°. The advantage of such a method of estimating residual orientation based on measuring two ATR-FTIR spectra is that it can be performed on a wide range of blends of PET- and/or PBT based polyesters, co-polyesters and blends.

According to the IDENT User Manual for the Opus Spectroscopy Software (Version 6) by Bruker the result of a comparison between two spectra (A and B) results in the spectral distance D. The better two spectra match, the smaller the spectral distance. Two spectra with a spectral distance of 0 are entirely identical (within the frequency ranges tested). The higher the difference between two spectra, the higher the spectral distance.

Spectral distance can be presented in the form of a value D. Different methods can be employed to calculate the value of the spectral distance D. One of these methods is the Standard algorithm which used the Euclidean distance to determine spectral distances. This Euclidean distance is based on:

$$D = \sqrt{{\sum }_{k} {( a ( k ) - b ( k ) )}^{2}}$$

where a(k) and b(k) are the ordinate values of the a and b spectra. The sum incorporates all selected k data points. This calculation is made by the software supplied with the Bruker spectrometer. So in the context of this description and claims all spectral distances D are Euclidean distances D. D is expressed as a scalar in this description and claims. A scalar is mathematically identical to a 1×1 matrix. So the terms “Euclidean distance matrix” and “Euclidean distance” mean the same in the context of this invention and are interchangeable.

Before this calculation the spectra must be pre-processed by vector normalisation. The average y value of the spectra is calculated and is subtracted from the spectrum, which causes the spectrum to be centred at around y=0. This is followed by calculating the sum of squares of all y values, and the respective spectrum is divided by the square root of this sum. The vector norm of the result spectrum is 1.

$$\begin{matrix}{a}_{m} = \frac{{\sum }_{k} a ( k )}{N} \\ {a}^{′} ( k ) = a ( k ) - {a}_{m} \\ {a}^{″} ( k ) = \frac{{a}^{′} ( k )}{\sqrt{{\sum }_{k} {( {a}^{′} ( k ) )}^{2}}} \\ {\sum }_{k} {( {a}^{″} ( k ) )}^{2} = 1\end{matrix}$$

If vector normalized spectra are represented in n dimensional space and n being the number of selected data points, all spectra are on the unit sphere (n dimensional sphere around the coordinate origin with radius 1). The maximum distance between two spectra is the diameter of the unit sphere, i.e. D=2. The minimum distance if all points of the two spectra are overlapping on the unit sphere, i.e. D=0.

The comparison of the two ATR-FTIR spectra is done by means of the Euclidean Distance D which is a measure for the degree in which the two ATR-FTIR spectra deviate. The inventors found that the target value for D_{adh} for the adhesion layer must be in the range of 0 to 0.10, whereas the target value for D_{bulk} for the bulk layer must be at least 0.10.

The machine direction (MD) of the laminated metal sheet is identical to the rolling direction (RD) of the metal sheet and also to the direction of movement of the metal sheet in the lamination process. The invention is particularly applicable for the case where the laminate layer is subsequently stretched only in the machine direction (MDO) or only in the transverse direction (TDO).

A value for D of zero means that the first and the second spectrum coincide in the observed range region and that there is no difference in orientation in the corresponding layer of the laminate layer in the two directions. A value of D>0 indicates the presence of residual orientation in the corresponding part of the laminate layer with a higher value of D being indicative of a greater difference between the two spectra which means that the orientation of the polymer chains of the laminate layer differs more in the two directions.

In an embodiment target value for D_{bulk} is at least 0.15, preferably at least 0.20, more preferably at least 0.30, and even more preferably at least 0.40.

In an embodiment the target value for D_{adh} is at most 0.08, preferably at most 0.06, more preferably at most 0.04, and even more preferably at most 0.03. A suitable minimum value for D_{adh} is 0.01.

In a preferable embodiment the ratio of D_{bulk}/D_{adh} is at least 1.50, preferably at least 5.00, more preferably at least 7.00, even more preferably at least 10.00 or even at least 12.50.

The invention is applicable to cases where the laminate layer before lamination onto the metal sheet has a distinct difference in orientation in the rolling direction and the transverse direction (TD). This is the case if the laminate layer before lamination is stretched only or predominantly in the machine directed orientation (MDO laminate layer) or only or predominantly in the transverse direction (TDO laminate layer). If the orientation in both directions (MD and TD) is the same before lamination, then D_{adh} and D_{bulk} are likely to be low before lamination. This is the case for biaxially oriented laminate layers that have been stretched in the MD and TD to the same or substantially the same extent, and for extruded laminate layers that are laminated directly upon the metal after extrusion without intermediate solidification and stretching after solidification. The invention does not apply to normal BO laminate layers wherein the amount of stretching in both perpendicular directions is the same or to the extruded laminate layers that are laminated directly upon the metal after extrusion without intermediate solidification and stretching after solidification. Laminate layers which are stretched in two perpendicular directions, but wherein the amount of stretching in one direction is significantly different are not considered to be biaxially oriented in the context of the invention, but these are considered to be a predominantly uniaxially oriented laminate layer.

The method of pre-heating the metal strip in the first heating device (2) is not particularly limited and may include passing the strip over heated rolls, conductive heating, inductive heating, radiative heating, etc. The method of post-heating the laminated metal sheet in the second heating device (6) is preferably a contactless method, such as heating in a hot gas environment or inductive heating. The method of cooling in the quenching device (7) is not particularly limited and may include applying cold air, water spray, mist or passing through a cold water bath.

Preferred embodiments of the method are provided by the dependent claims 2 to 11.

In an embodiment the first in-plane orientation of the incident IR-beam is parallel or perpendicular to the machine direction of the laminated metal sheet or corresponding free-standing laminate layer.

In an embodiment the first in-plane orientation of the incident IR-beam of the laminated metal sheet is measured and wherein the second ATR FTIR spectrum is measured after rotating the laminated metal sheet or a sample of corresponding free-standing laminate layer over an angle alpha in the plane of the laminate layer to a second in-plane orientation selected between 85° and 95°, preferably wherein the angle alpha is about 90°.

In an embodiment the adhesion layer i. contains or comprises a copolyester having 3.5 to 12.5 wt. % ethylene-isophthalate units, preferably having 4.0 to 11.0 wt. % ethylene-isophthalate units, or ii. contains or comprises a copolyester having 60 to 100 wt. % of a non-crystallisable copolyester, preferably having 80 to 100 wt. % of a non-crystallisable copolyester.

In an embodiment the laminate layer comprises also an additional top layer (TL) on top of the bulk layer (B), wherein the additional top layer (TL) may contain one or more individual layers. The additional top layer may be more or less identical to the bulk layer (B) in composition and/or thickness, or they may be identical in polymer composition but, either one may contain additives like the additional top layer containing slip additives and anti-block particles, and the bulk layer may contain colouring agents, dyes, toners or pigment particles.

In a preferable embodiment the laminate layer for coating onto at least one side of the metal sheet contains two or more layers and is provided by:
melting thermoplastic polymer granules in one or more extruders;
forming the laminate layer consisting of the two or more layers by passing the molten polymer or polymers through an extrusion die and/or two or more calendering rolls; optionally followed by:
cooling the laminate layer to form a solid laminate layer;
optionally trimming the edges of the laminate layer;
reducing the thickness of the solid laminate layer by stretching the solid laminate layer in a stretching unit by exerting a stretching force only in the longitudinal direction or only in the transverse direction;
   optionally trimming the edges of the stretched laminate layer.

The reduction of the thickness of the solid laminate layer as a result of the stretching is at least 50%, preferably at least 60% and more preferably at least 65%. The degree of orientation of the laminate layer is directly linked to the amount of reduction. The higher the amount of reduction, the higher the degree of orientation as a result of the orientation of the polymer chains in the laminate layer. A higher degree of uniaxial orientation of the laminate layer is considered beneficial for the method according to the invention as it allows to reach a higher ratio of D_{bulk}/D_{adh}.

The extrusion may of the multilayer laminate layer may be performed by extruding individual polymer layers through a plurality of individual flat extrusion dies, or by extruding a plurality of individual polymer layers through a co-extrusion die.

In an embodiment the laminate layer (3) is laminated onto the metal sheet to produce a laminated metal sheet without interruption in an in-line and continuous process. This means that the production of the laminate layer immediately precedes the lamination process without intermediate cutting, coiling and uncoiling of the laminate layer, but instead that it is applied to the metal sheet without interruption of the individual processing steps.

In an embodiment the method according to the invention is used to adjust the process parameters of a continuous coating line, such as one or more of the pre-heat set-point (T1), the mandatory post-heat set-point (T2) and the line speed (v) of the continuous coating line, if the Euclidean distance D_{adh} after post-heating and cooling is above its target value and/or if D_{bulk} after post-heating and cooling is below its target value. As soon as post-heat set-point (T2) is not applied or if it is applied and the D_{adh} is more than and D_{bulk} is less than their corresponding threshold values, the adhesion of the laminate layer on one hand and the degree of orientation of the laminate layer on the other hand are not sufficient and the product is likely to underperform, which may lead to rejection or declassification of the material to a lower value product.

In an embodiment the metal sheet is a steel sheet, preferably wherein the steel is uncoated cold-rolled steel, blackplate, tinplate (i.e. steel coated with a thin layer of tin, usually intended for packaging applications), ECCS (aka TFS), TCCT® (a Tata Steel registered trademark), galvanised steel or aluminised steel. In another embodiment the metal sheet is an aluminium or aluminium alloy sheet. The metal sheet is preferably supplied in coiled form and the thickness is typically between 0.15 and 0.40 mm. The laminated metal sheet is preferably also supplied in coiled form, although it can also be supplied to customers in the form of cut-to-length metal sheets or blanks.

The method for determining of D_{bulk} in the laminate layer of the laminated metal sheet obtained by lamination of (predominantly) uniaxially oriented polyester-based film comprises the following steps:
a. Obtaining a sample of the laminated metal sheet;
b. Placing the sample of the laminated metal sheet on the ATR detector of the ATR-FTIR spectrometer so that the rolling direction of laminated metal sheet is parallel to a plane of incidence of infrared light from spectrometer infrared light source onto the ATR crystal;
c. Recording the reflectance profile at least over the frequency range 1160-1520 cm⁻¹;
d. Generating, using Fourier transformation, a first ATR-FTIR spectrum of the sample in this frequency range;
e. Rotating the sample of a laminated metal sheet in the plane perpendicular to the sample surface normal over an angle alpha selected between 70° and 110° and repeating step c and d to produce a second ATR-FTIR spectrum;
f. Mathematically comparing the correlation between the first and the second spectrum at least in the 1160-1520 cm⁻¹ frequency range by calculating the spectral distance as expressed in a Euclidean distance D_{bulk} between the two spectra.

The method for determining of D_{adh} in the laminate layer of the laminated metal sheet additionally includes between the steps a and b, the step of obtaining free-standing laminate layer by dissolution of the metal sheet from the metal laminate and repeating steps b through f on the metal facing side of the free-standing laminate layer.

The laminated metal sheet according to the invention may be provided with a laminate layer on one or on both sides of the metal sheet. In the latter case the laminate layers (3a, 3b in FIG. 1) may be identical in terms of composition, thickness or build-up, or they may be different.

The method of pre-heating the metal strip before laminating the laminate layer thereupon is not particularly limited and may include passing the strip over heated rolls, conductive heating, inductive heating, radiative heating, etc. The method of post-heating of the laminated metal sheet is preferably a contactless method, such as heating in a hot gas environment or inductive heating. In a preferable embodiment the post-heating of the laminated metal sheet to the pre-heat set-point T1 and/or the post-heat set-point T2 is performed by means of induction heating. With induction heating the metal sheet is heated from within which prevents the outer polymer layers of becoming too hot, and thereby prevents the melting of the bulk layer (B) or any other additional layers (TL) on top of the bulk layer.

According to a second aspect of the invention is also embodied in a laminated metal sheet (9) for packaging applications obtainable or obtained by the method according to the invention, the laminated metal sheet comprising a metal sheet (1) and a laminate layer (3) that covers at least one side of the metal sheet, wherein the laminate layer (3) comprises an adhesion layer (A) and a bulk layer (B), wherein the adhesion layer is bonded to the metal sheet and contains or comprises a copolyester having 5-30% ethylene-isophthalate units, 80-95% ethylene-terephthalate units and 0-5% other units and wherein the bulk layer consists essentially of poly(ethylene terephthalate) having at least 90% ethylene-terephthalate units, wherein the adhesion layer (A) and the bulk layer (B) optionally each contain(s) additives like slip additives and anti-block particles, and wherein the bulk layer (B) optionally further contains colouring agents, dyes, toners or pigment particles, wherein the laminated metal sheet has a value for the Euclidean distance matrix D_{adh} of the adhesion layer (A) between a first and a second ATR FTIR spectrum of the adhesion layer (A) having a value in the range of 0 to 0.10, and a value for the Euclidean distance matrix D_{bulk} of the bulk layer (B) between a first and a second ATR FTIR spectrum of the bulk layer (B) having a value in the range of 0.10 or higher wherein the first ATR FTIR spectrum is measured in an ATR-FTIR spectrometer with the incident IR-beam in a first in-plane orientation to the machine direction of the laminated metal sheet or corresponding free-standing laminate layer and wherein the second ATR FTIR spectrum is measured in the ATR FTIR spectrometer after rotating the laminated metal sheet or corresponding free-standing laminate layer over an angle alpha in the plane of the laminate layer selected between 70° and 110° to a second in-plane orientation, and wherein the ATR-FTIR spectra are measured in the spectral range which includes the range of 1160 to 1520 cm⁻¹, and preferably wherein D_{bulk}/D_{adh} is at least 1.50.

In an embodiment D_{bulk}/D_{adh} is at least 1.50. The higher the ratio, the better the overall performance of the laminated metal sheet.

It is preferable that the fraction recrystallised of the bulk layer in the laminate layer is at least 20 wt. %, preferably at least 25 wt. %, more preferably at least 30%. This ensures maintaining the favourable bulk layer properties good barrier properties and corrosion resistance at a sufficiently high level. The higher the fraction recrystallised, the better for maintaining the bulk layer properties.

In an embodiment the laminate layer is predominantly or solely oriented in the machine direction or predominantly or solely perpendicular to the machine direction as a result of stretching during the production of the laminate layer in a stretching unit by exerting a stretching force only in the longitudinal or only in the transverse direction wherein the thickness reduction of the solid laminate layer as a result of the stretching is at least 50%, more preferably at least 60%, even more preferably at least 65%.

According to a third aspect the invention is also embodied in a can body or a can end or a can lid that is produced from the laminated metal sheet according to the invention.

The invention is also embodied in a process for making a seamless container body from the laminated metal sheet produced according to the invention characterised by drawing from the laminated metal sheet a cup having an end wall and a side wall upstanding from the periphery of the end wall wherein at least one side of the cup is covered with the laminate layer, preferably wherein both sides of the cup are covered with the laminate layer. In case of a lid or a can body, preferably at least the inside of the cup is covered with the laminate layer.

The invention is also embodied in a process for making a seamless container body from a laminated metal sheet by drawing from the laminate a cup having an end wall and a side wall upstanding from the periphery of the end wall optionally followed by a further step of forming a can body by redrawing the cup to reduce the diameter of the cup and increase the height of said wall. The can body may also be subjected to wall ironing.

In an embodiment a laminated metal sheet (9) is provided wherein the adhesion layer (A) i. contains or comprises a copolyester having 5-15 wt. % ethylene-isophthalate units, 80-95 wt. % ethylene-terephthalate units and 0-5 wt. % other components, ii. or contains or comprises 60-100 wt. % of a non-crystallisable copolyester, 0-40 wt. % of a crystallisable polyester or copolyester or a blend thereof such as (e.g.) polyethylene-terephthalate and 0-10 wt. % other components, while the main polymer resin used in the one or multiple of additional top layers is poly(ethylene terephthalate) having at least 90% ethylene-terephthalate units, and wherein the adhesion layer (A) and the bulk layer (B) optionally each contain(s) additives like slip additives and anti-block particles, and wherein the bulk layer (B) optionally further contains colouring agents, dyes, toners or pigment particles.

The invention is also embodied in a process for making a can end or a can lid from the laminated metal sheet produced according to the invention by known means.

### EXAMPLES

To illustrate the present invention, laminated metal sheets were produced. In all cases a metal sheet is provided on both sides with a thermoplastic polymer laminate layer. The metal sheet is a low carbon cold-rolled packaging steel commonly referred to as Electrolytically Chromium Coated Steel (“ECCS”), which is electrolytically coated on both sides with metallic chromium and a layer of chromium oxide where a total amount of chromium on each side is approximately 90 mg/m². The metal sheet is provided as a coiled metal strip

The laminate layers in Table 1 were used to produce the comparative and test samples according to the invention. The laminate layers in Table 1 were produced by casting a polymer film and stretching it uniaxially in the machine direction (MDO) with draw ratio of 1:4, employing different laminate layer compositions. The total laminate layer thickness was 20 μm, with an adhesion layer (A) of 4 μm, a bulk layer (B) of 12 μm and an additional top layer (TL) of 4 μm.

TABLE 1
Laminate layers

| | t | Orient. | Release | Adhesion layer | Bulk Layer | Top Layer |
|---|---|---|---|---|---|---|
| Code | (μm) | Draw ratio | agent MB* | (A) | (B) | (TL) |
| PET1 | 20 | MDO | 2% | 100% i-PET CA248 | 100% | 100% |
| | (1/3/1) | 1:4 | | (PET containing | PET | PET |
| | | | | 10% ethylene- | | |
| | | | | isophthalate units) | | |
| PET2 | 20 | MDO | 2% | 90% PETg | 100% | 100% |
| | (1/3/1) | 1:4 | | 10% PET | PET | PET |
| PET3 | 20 | MDO | 2% | 100% i-PET CA248 | 67% PET | 100% |
| | (1/3/1) | 1:4 | | (10% ethylene- | 33% TiO₂ MB | PET |
| | | | | isophthalate units) | | |

PETg = glycol-modified polyester resin, grade Eastar 6763 by Eastman
PET = bottle-type polyester resin, grade N180 by Indorama
MB = PET-based, white-coloured masterbatch containing 50 wt. % TiO2, grade TA 76-98 MB03 by Sukano
i-PET CA248 = isophthalic acid modified polyester resin, grade Bondz CA248 by Selenis

The laminate layers were laminated onto the metal sheet by a heat bonding process schematically shown in FIG. 1. The metal strip or sheet (1) is passed through a first heating device (2) where the temperature of the metal strip is raised to the pre-heat set-point T1 suitable for lamination. Coils of film (3a, 3b) of the laminate layers are simultaneously unwound and passed, together with the pre-heated metal strip or sheet, through a pair of laminating rollers (4a, 4b). It is clear that this process is also applicable if only one side of the metal sheet is coated. The resulting laminated metal strip or sheet (5) is passed through a second heating device (6) where the temperature of the laminated strip is raised to the post-heat set-point, T2 e.g. by means of induction heating. After the second heating device, the laminated metal sheet is immediately cooled by passing through a quenching device (7) to reach ambient temperature (usually this is room temperature). The method of pre-heating the metal strip in the first heating device is not particularly limited and may include passing the strip over heated rolls, conductive heating, inductive heating, radiative heating, etc. The method of post-heating the laminated metal sheet in the second heating device is preferably a contactless method, such as heating in a hot gas environment or inductive heating. The method of immediate cooling in the quenching device is not particularly limited and may include applying cold air, water spray, mist, or passing through a cold-water bath. The laminated metal sheet is then passed through drying rollers (8a, 8b), after which samples can be collected for acquisition of ATR-FTIR profile on the samples of metal laminates and corresponding free-standing laminate layers. In the normal production process the laminated metal sheet is normally coiled after passing through the drying rollers (not shown) for shipping to the customer.

Table 2 specifies comparative (“CS”) and inventive samples (“TS”). Table 2 also specifies the corresponding process conditions used to obtain those samples.

For flat samples the definition of which side is the outside and which is the reverse is arbitrary. For the application in a can, the outside represents the exterior side of the can, and the reverse side is the interior side of the can contacting its contents. After production of the samples, ATR-FTIR spectra were recorded at the laminated metal sheet and spectral distances D_{bulk} values were determined. For determining D_{adh}, it was necessary to analyse the free-standing laminate layers. Free-standing laminate layers were obtained by placing a sample of metal laminate from the line in 18% hydrochloric acid in water to dissolve the metal sheet.

TABLE 2
Process conditions used to produce
comparative and inventive samples

| | | | Pre-heat | Post-heat |
|---|---|---|---|---|
| | Film type | V | conditions | conditions |
| Sample | (outside) | (m/min) | T1 (° C.) | T2 (° C.) |
| CS1 | PET1 | 20 | 200 | No post-heat |
| CS2 | PET1 | 20 | 200 | 200 |
| TS1 | PET1 | 20 | 200 | 210 |
| TS2 | PET1 | 20 | 200 | 220 |
| CS3 | PET1 | 20 | 200 | 230 |
| CS4 | PET1 | 20 | 200 | 240 |
| CS5 | PET1 | 20 | 200 | 250 |
| CS6 | PET2 | 20 | 200 | No post-heat |
| CS7 | PET2 | 20 | 200 | 200 |
| TS3 | PET2 | 20 | 200 | 210 |
| TS4 | PET2 | 20 | 200 | 220 |
| CS8 | PET2 | 20 | 200 | 230 |
| CS9 | PET2 | 20 | 200 | 240 |
| CS10 | PET2 | 20 | 200 | 250 |
| CS11 | PET3 | 20 | 200 | No post-heat |
| CS12 | PET3 | 20 | 200 | 200 |
| TS5 | PET3 | 20 | 200 | 210 |
| TS6 | PET3 | 20 | 200 | 220 |
| CS13 | PET3 | 20 | 200 | 230 |
| CS14 | PET3 | 20 | 200 | 240 |
| CS15 | PET3 | 20 | 200 | 250 |

Samples of laminated metal sheet were cut as 5.0×5.0 cm panels. ATR-FTIR spectra were recorded using a Bruker Tensor II ATR-FTIR spectrometer equipped with diamond crystal with a fixed predetermined incident angle of 45°. The ATR-FTIR signal was recorded using 16 scans at 1160-1520 cm⁻¹ with a 0.4 cm⁻¹ resolution. Prior to recording the actual ATR-FTIR spectra, the background signal was recorded.

For each sample, two spectra were recorded: first spectrum was recorded with the sample of laminated metal sheet or free-standing laminate layer at the metal facing side in rolling direction (which is identical to the machine direction (MD) of the continuous coating line) perpendicular to a plane of incidence of infrared light from spectrometer infrared light source onto ATR crystal, and second spectrum was recorded after rotating the metal laminate sample or free-standing laminate layer at the metal facing side by 90° in plane of the sample

Mathematical comparison of first and second spectra corresponding to the adhesion layer (A) and bulk layer (B) was achieved by calculating spectral distance values D after vector normalization (to compensate for the difference in intensities due to surface defects) in the spectral range of 1160 to 1520 cm⁻¹. Calculated spectral distance values D_{bulk} and D_{adh} are Euclidean distances between the corresponding two spectra. The calculated Euclidean distance can fall in the range from 0 (complete match of spectra) to 2 (complete mismatch of spectra). As a threshold, D_{bulk}, D_{adh}=0.10 was identified by comparing results of known good and bad samples. The mathematical background is well known to the skilled person and a summary thereof can be found i.a. in document WO2021/180651-A1 on page 11 lines 11 to 38, which section is incorporated herein by reference.

The thermal properties (Tg, Tm, bulk crystallinity) of the laminate layers were determined by DSC. The spectra were recorded using a Mettler Toledo DSC821e instrument operated at 10° C./min heating rate. For DSC, it was necessary to analyse the free-standing films obtained from the laminated metal sheet. Free-standing laminate layers were obtained by placing a sample of metal laminate from the line in 18% hydrochloric acid in water to dissolve the metal sheet. After dissolution of the metal sheet, the laminate layers were thoroughly rinsed and dried. The crystalline fraction was determined from the heat of recrystallization and the heat melting recorded during the first heating run as described in detail elsewhere. Orientation-induced crystallinity values (in wt. %) were calculated from ratio:

$$X = \frac{\vert Δ {H}_{m} \vert - \vert Δ {H}_{r} \vert}{Δ {H}_{0}} \times 100 \%$$

where ΔHᵣ is the observed area of recrystallization peak and ΔHₘ is the observed area of melting peak, and ΔH₀ is an enthalpy of fusion for 100% crystalline PET assumed to be 115.0 J/g (J. Brandrup, E. H. Immergut, E. A. Grulke et al, Polymer Handbook, Wiley Interscience, 4^{th} ed (1999), Section VI, Table 7)

Adhesion performance on the flat material was evaluated using 180 degree peel test according to ISO 11339:2010. The test was performed using Instron 5587 tensile tester equipped with pneumatic grips, operated at a cross-head speed of 25 mm/min, using the 15 mm wide strips that were cut in the rolling direction from the wider laminate sheet. Prior to cutting, the initiation point for the peel test was obtained on the sheet by etching off the edge of the metal laminate in 18% hydrochloric acid to partially dissolve the steel base. The peel force is defined as the average first peak load, expressed in N/15 mm, by testing 5 specimens. Several samples of laminated metal sheets had brittle laminate layer which was breaking off before first peak load value could be recorded. In this case, the force at maximum load for the free-standing laminate layers in rolling direction was additionally evaluated to confirm that the breaking off of the laminate layer was due to high laminate layer adhesion rather than the brittleness of the laminate layer itself. The force at maximum load, expressed in N/15 mm, is defined by the equation F=d×w×σ, where d and w are the thickness and width of the laminate layer, respectively. In the case of current work d and w values are 20 micron and 15 mm, respectively. σ is the tensile stress determined according to ISO 527. The tensile stress is defined as the average tensile stress at maximum load, expressed in MPa, by testing 5 specimens of 10 mm wide strips cut from the free-standing laminate layers in rolling direction.

Adhesion performance on the deformed dry (as-produced) or wet (sterilised) material was evaluated as follows. First, deformation was applied using “Erichsen Cupping Test” as described in ISO 20482:2013. The cup height of 5 mm was applied in all cases. For sterilisation the deformed panels of 7.5×15.0 cm were placed in an aqueous solution containing 12 g/l of commercially available Maggi® bouillon (dehydrated broth powder or cubes)+2 g/l plasmal in a closed container and subsequently sterilised at 121° C. during 90 min and next the samples were cooled down. Adhesion on the dry and wet deformed samples was then evaluated by applying so-called “X-cut Pull-Off” method. In that method an X-cut is applied to the deformed portion of the non-sterilised and sterilised panels followed by adhesive tape (3M Scotch Nr. 610) according to the method described in ASTM D3359. After that delamination is evaluated using the scale ranging from 0 (excellent) to 5 (bad) (Table 3). All tests were performed in triplo for each side of each variant of laminated metal sheet from Table 2. The score was then averaged over the three results and rounded to the nearest whole number.

Cracking susceptibility was evaluated on the deformed material. Deformation was achieved using “Erichsen Cupping Test” as described in ISO 20482:2013 using the cup height of 5 mm. Presence of cracks at the tip of the cup was evaluated by collecting optical images with the Olympus BX51M microscope equipped with the Objective 20× or 50×. The optical images were acquired by focusing on the outer layer of the polymer coatings. The level of cracking is evaluated as “None”, “Small” or “Severe” (Table 4).

TABLE 3
Classification of “Erichsen Cupping Test” results

| Score | Description |
|---|---|
| 0 | No peeling or removal |
| 1 | Trace peeling or removal along incisions or at their intersection |
| 2 | Jagged removal along incision up to 1.6 mm on either side |
| 3 | Jagged removal along incisions up to 3.2 mm on either side |
| 4 | Removal of most of the area of the “X” |
| 5 | Removal beyond the areas of the “X” |

TABLE 4
Classification of cracking susceptibility test results

| Score | Description |
|---|---|
| None | No cracks |
| Small | Cracks <10 μm |
| Severe | Cracks >20 μm |

All characterisation data for test and comparative samples are summarised in Table 5. The characterisation data on free-standing laminate layers and adhesion and sterilisation data on metal-laminate samples are then compared with spectral distance values D_{bulk} and D_{adh} as well as the values for the ratio D_{bulk}/D_{adh}. Values of D_{bulk} and D_{adh} were derived by comparing first and second ATR-FTIR spectra determined for corresponding metal-laminates or free-standing laminate layers.

It is evident from these results that the application of a laminate layer onto a metal sheet without a post-heat according to the invention results in a badly performing laminated metal sheet (CS1/CS6/CS10). It is also evident from this table that the larger the ratio of D_{bulk}/D_{adh} the better the performance of the laminated metal sheet was provided when D_{bulk}>0.10 and D_{adh}<0.10.

### BRIEF DESCRIPTION OF THE DRAWINGS

The invention will be explained by means of the following, non-limiting figures.

FIG. 1 shows a schematic drawing of an industrial continuous coating line.

FIG. 2 shows a schematic drawing of the distance between two spectra.

FIG. 3 shows spectra of a sample with large anisotropy.

FIG. 4 shows spectra of an isotropic sample.

FIG. 5 shows some embodiments of laminated metal sheet:
a). Metal sheet (1), adhesion layer (A) and bulk layer (B) on one side of the metal sheet;
b). Metal sheet (1), adhesion layer (A) and bulk layer (B) on both sides of the metal sheet;
c). Metal sheet (1) and adhesion layer (A), bulk layer (B) and additional top layers (TL) on one side of the metal sheet only;

FIG. 6 shows a schematic explanation of measurement of the ATR-FTIR-spectra.

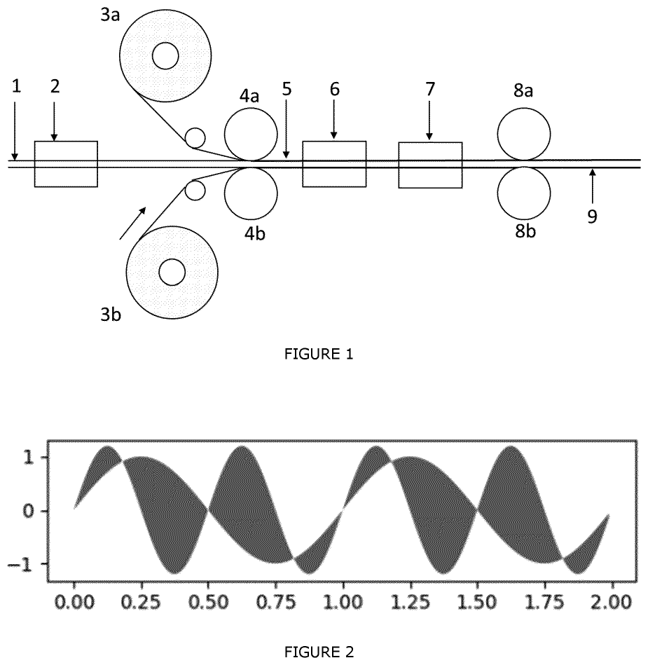

The laminate layers are laminated to the metal strip by a process schematically shown in FIG. 1 as described herein above.

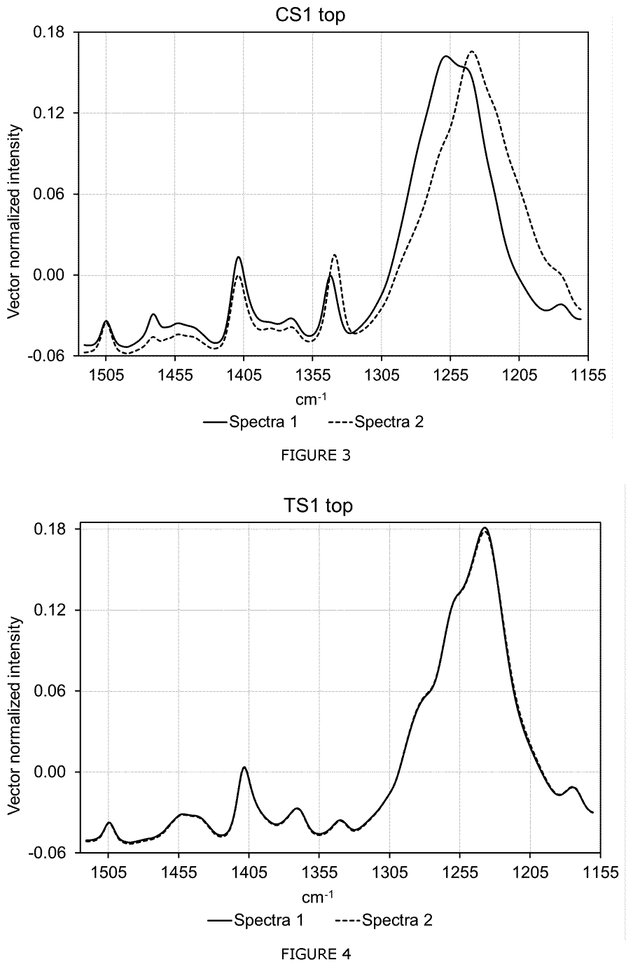

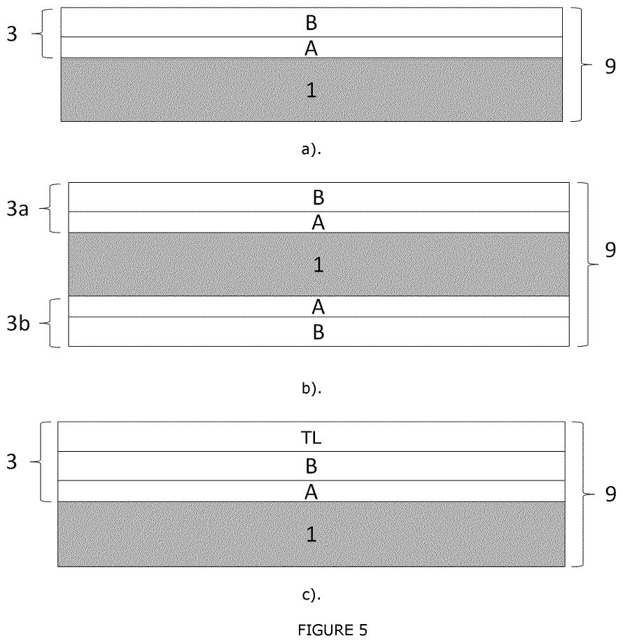

The spectral distance D is proportional to the area between two curves. In FIG. 2 two model sine curves are depicted. The spectral distance is proportional to the grey area between the two sine curves. FIG. 3 shows two curves of two different polymer layers with a difference in ATR-FTIR response and this shows a significant orientation difference between the two perpendicular directions in which the ATR-FTIR response was measured, FIG. 4 shows two curves of two different polymer layers with the same ATR-FTIR response (so with a very low D) showing practically no difference in orientation, indicative of a random orientation of the polymer chains or an amorphous microstructure.

FIG. 5 shows the schematic build-up of a laminated metal sheet. The top drawing shows the simplest form of laminated metal sheet 9 with the metal sheet 1 provided with one laminate layer 3 consisting of an adhesion layer (A) and a bulk layer (B). FIG. 5b shows the same laminate layer of FIG. 5a on both sides of the metal sheet 1. FIG. 5c shows a more complicated embodiment according to the invention where the metal sheet 1 is provided with a multilayer laminate layer 3 on top, wherein the multilayer (in this example) consists of three separate layers TL, B and A serving as an additional top layer, bulk layer and adhesion layer respectively, each potentially having a different composition tailored to the requirements posed to the individual separate layer.

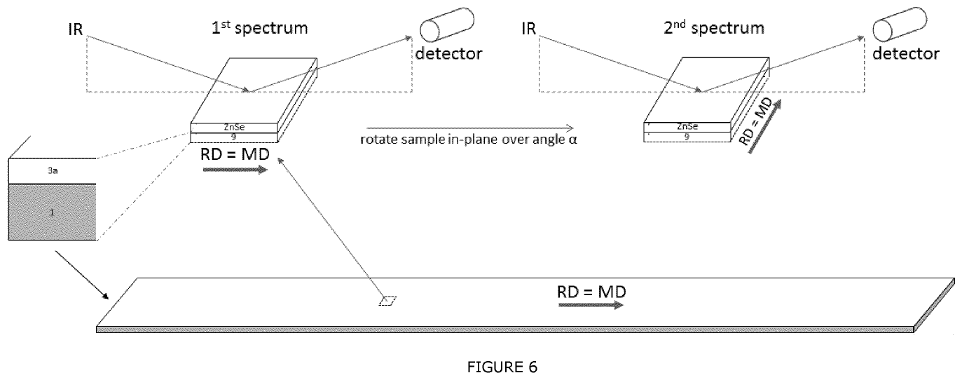

FIG. 6 shows a schematic interpretation of the preparation of a sample taken from a laminated metal sheet and the subsequent measurements in the ATR-FTIR spectrometer. The first spectrum is measured with the direction of the incident IR-beam parallel to the machine direction (MD), which is the same as the rolling direction (RD), and the second spectrum is measured with the direction of the incident IR-beam more or less perpendicular (angle of rotation «) to the machine direction. The Euclidean distance D is determined between these two spectra.

TABLE 5
Characterisation data of comparative (CS) and inventive (TS) laminated metal sheet samples.

| | | | | | Peel Force | Force at Max Load | | | | | | | | |
|---|---|---|---|---|---|---|---|---|---|---|---|---|---|---|
| | | | T2 | X | (Metal Laminate) | (Laminate layer) | Summary | Dome 5 mm | | | | | D_{bulk}/ | Sample |
| [symbol] ple | Film | Orient. | (° C.) | (wt. %) | (N/15 mm) | (N/15 mm) | adhesion | Dry | Wet | Cracking | D_{adh} | D_{bulk} | D_{adh} | quality |
| [symbol] 1 | PET1 | MDO | none | 43 | <0.2 | | Low | 5 5 5 | 5 5 5 | None | 0.40 | 0.45 | 1.12 | −− |
| [symbol] 2 | PET1 | MDO | 200 | 42 | 0.5 | | Low | 2 2 2 | 5 5 5 | None | 0.33 | 0.47 | 1.42 | −− |
| [symbol] 1 | PET1 | MDO | 210 | 40 | 12.4 | | High | 0 0 0 | 0 0 0 | None | 0.03 | 0.43 | 14.33 | ++ |
| [symbol] 2 | PET1 | MDO | 220 | 40 | 14.7 | | High | 0 0 0 | 0 0 0 | Small | 0.02 | 0.42 | 21.00 | ++ |
| [symbol] 3 | PET1 | MDO | 230 | 10 | 10.0 | | High | 0 0 0 | 1 1 1 | Severe | 0.02 | 0.03 | 1.50 | −− |
| [symbol] 4 | PET1 | MDO | 240 | 4 | 12.4 | | High | 0 0 0 | 1 1 1 | Severe | 0.02 | 0.004 | 0.20 | −− |
| [symbol] 5 | PET1 | MDO | 250 | 2 | 12.0 | | High | 0 0 0 | 0 1 1 | Severe | 0.02 | 0.04 | 2.00 | −− |
| [symbol] 6 | PET2 | MDO | none | 36 | 0.3 | | Low | 5 5 5 | 0 0 0 | None | 0.02 | 0.42 | 21.00 | −− |
| [symbol] 3 | PET2 | MDO | 200 | 36 | Break-off | 68.4 | High | 0 0 0 | 1 1 1 | None | 0.03 | 0.44 | 14.67 | ++ |
| [symbol] | PET2 | MDO | 210 | 40 | Break-off | 68.0 | High | 0 0 0 | 0 0 0 | None | 0.02 | 0.45 | 22.50 | ++ |
| [symbol] 5 | PET2 | MDO | 220 | 41 | 9.0 | | High | 0 0 0 | 0 0 0 | None | 0.02 | 0.16 | 8.00 | ++ |
| [symbol] 7 | PET2 | MDO | 230 | 7 | 9.3 | | High | 0 0 0 | 0 0 0 | Severe | 0.02 | 0.03 | 1.50 | −− |
| [symbol] 8 | PET2 | MDO | 240 | 4 | 9.3 | | High | 0 0 0 | 0 0 0 | Severe | 0.03 | 0.02 | 0.67 | −− |
| [symbol] 9 | PET2 | MDO | 250 | 2 | 11.9 | | High | 0 0 0 | 0 0 0 | Severe | 0.01 | 0.05 | 5.00 | −− |
| 10 | PET3 | MDO | none | 40 | <0.2 | | Low | 5 5 5 | 5 5 5 | None | 0.41 | 0.47 | 1.15 | −− |
| 11 | PET3 | MDO | 200 | 41 | 0.4 | | Low | 5 5 5 | 4 5 5 | None | 0.35 | 0.47 | 1.34 | −− |
| [symbol] 6 | PET3 | MDO | 210 | 35 | Break-off | 63.8 | High | 0 0 0 | 0 0 0 | None | 0.01 | 0.45 | 45.00 | ++ |
| [symbol] 7 | PET3 | MDO | 220 | 32 | 8.7 | | High | 0 0 0 | 0 0 0 | None | 0.02 | 0.41 | 20.50 | ++ |
| 12 | PET3 | MDO | 230 | 5 | 10.2 | | High | 0 0 0 | 1 1 1 | Severe | 0.02 | 0.01 | 0.50 | −− |
| 13 | PET3 | MDO | 240 | 4 | 11.2 | | High | 0 0 0 | 1 1 1 | Severe | 0.02 | 0.01 | 0.50 | −− |
| 14 | PET3 | MDO | 250 | 7 | 11.9 | | High | 0 0 0 | 1 1 1 | Severe | 0.02 | 0.002 | 0.10 | −− |

[symbol]

indicates data missing or illegible when filed

1. A method for producing a laminated metal sheet in a continuous coating line operating at a line speed v, the laminated metal sheet comprising a laminate layer, the method comprising the subsequent steps of:
a. providing a metal sheet;
b. providing a predominantly or solely uniaxially oriented laminate layer for coating onto at least one side of the metal sheet, the laminate layer comprising at least an adhesion layer (A) and a bulk layer (B) and optionally one or more additional top layers (TL) on top of the bulk layer, wherein the adhesion layer (A) is intended for bonding to the metal sheet and either i). contains or comprises a copolyester having 5-30 wt. % ethylene-isophthalate units, 70-95 wt. % ethylene-terephthalate units and 0-5 wt. % other components, or ii) contains or comprises 60-100 wt. % of a non-crystallisable copolyester, 0-40 wt. % of a crystallisable polyester or copolyester or a blend thereof and 0-10 wt. % other components, and wherein the bulk layer (B) and the optional one or more additional top layers (TL) on top of the bulk layer consist essentially of poly(ethylene terephthalate) having at least 90% ethylene-terephthalate units, wherein the adhesion layer (A), the bulk layer (B) and the optional one or more additional top layers (TL) on top of the bulk layer each optionally contain(s) additives, and wherein the bulk layer optionally contains colouring agents, dyes, toners, or pigment particles;
c. pre-heating the metal sheet to a pre-heat set-point temperature T1 wherein T1 is sufficiently high to provide initial adhesion to the laminate layer but not so high as to melt the bulk layer (B) nor any of the optional additional top layers (TL) in the laminate layer;
d. laminating the laminate layer onto the metal sheet to produce a laminated metal sheet;
e. post-heating the laminated metal sheet to a post-heat set-point temperature T2 without melting the bulk layer (B) nor any of the optionally present additional top layers (TL) in the laminate layer and wherein T2 is sufficiently high to produce a value of D_{adh} dh in the range of 0 to 0.10 after cooling the post-heated laminated metal sheet;
f. cooling the post-heated laminated metal sheet to produce a laminated metal sheet with a value for the Euclidean distance D_{adh} of the adhesion layer (A) between a first and a second ATR FTIR spectrum of the adhesion layer (A) having a value in the range of 0 to 0.10, and a value for the Euclidean distance D_{bulk} of the bulk layer (B) between a first and a second ATR FTIR spectrum of the bulk layer (B) having a value in the range of 0.10 or higher, and wherein the first ATR FTIR spectrum is measured in an ATR-FTIR spectrometer with the incident IR-beam in a first in-plane orientation to the machine direction of the laminated metal sheet or corresponding free-standing laminate layer and wherein the second ATR FTIR spectrum is measured in the ATR-FTIR spectrometer after rotating the laminated metal sheet or corresponding free-standing laminate layer over an angle alpha (α) in the plane of the laminate layer selected between 70° and 110° to a second in-plane orientation, and wherein the ATR-FTIR spectra are measured in the spectral range which includes the range of 1160 to 1520 cm⁻¹.

2. The method according to claim 1, wherein the first in-plane orientation of the incident IR-beam is parallel or perpendicular to the machine direction of the laminated metal sheet or corresponding free-standing laminate layer.

3. The method according to claim 1, wherein the first in-plane orientation of the incident IR-beam of the laminated metal sheet or corresponding free-standing laminate layer is measured and wherein the second ATR FTIR spectrum is measured after rotating the laminated metal sheet or corresponding free-standing laminate layer over an angle α in the plane of the laminate layer to a second in-plane orientation selected between 85° and 95°.

4. The method according to claim 1, wherein the adhesion layer (A) contains or comprises a copolyester having 3.5-12.5 wt. % ethylene-isophthalate units.

5. The method according to claim 1, wherein the adhesion layer (A) contains or comprises a copolyester having 4.0-11.0 wt. % ethylene-isophthalate units.

6. The method according to claim 1, wherein the adhesion layer(S) contains or comprises 80-100 wt. % of a non-crystallisable copolyester.

7. The method according to claim 1, wherein the target value for D_{bulk}/D_{adh} is at least 1.50.

8. The method according to claim 1, wherein the laminate layer comprises also at least one or more additional top layers (TL) on top of the bulk layer (B).

9. The method according to claim 1, wherein the laminate layer for coating onto at least one side of the metal sheet is provided by:
melting thermoplastic polymer granules in one or more extruders to produce a molten polymer or polymers having the required composition for producing the adhesion layer (A), bulk layer (B) and optional additional top layer(s) (TL);
forming the laminate layer comprising the two or more layers by passing the molten polymer or polymers through an extrusion die and/or two or more calendering rolls;
optionally followed by:
cooling the laminate layer to form a solid laminate layer;
optionally trimming the edges of the solid laminate layer;
reducing the thickness of the solid laminate layer by stretching the solid laminate layer in a stretching unit by exerting a stretching force only in the longitudinal direction or only in the transverse direction; and
optionally trimming the edges of the stretched solid laminate layer.

10. The method according to claim 1, wherein the laminate layer is laminated onto the metal sheet to produce a laminated metal sheet without interruption in a continuous process.

11. The method according to claim 1, wherein the metal sheet is a steel.

12. A laminated metal sheet for packaging applications obtainable or obtained by the method according to claim 1,
the laminated metal sheet comprising a metal sheet and a laminate layer that covers at least one side of the metal sheet, wherein the laminate layer comprises an adhesion layer (A) and a bulk layer (B), wherein the adhesion layer is bonded to the metal sheet and contains or comprises a copolyester having 5-30% ethylene-isophthalate units, 80-95% ethylene-terephthalate units and 0-5% other units and wherein the bulk layer consists essentially of poly(ethylene terephthalate) having at least 90% ethylene-terephthalate units, wherein the adhesion layer (A) and the bulk layer (B) optionally each contain(s) additives, and wherein the bulk layer (B) optionally further contains colouring agents, dyes, toners or pigment particles,
wherein the laminated metal sheet has a value for the Euclidean distance D_{adh} of the adhesion layer (A) between a first and a second ATR FTIR spectrum of the adhesion layer (A) having a value in the range of 0 to 0.10, and a value for the Euclidean distance D_{bulk} of the bulk layer (B) between a first and a second ATR FTIR spectrum of the bulk layer (B) having a value in the range of 0.10 or higher wherein the first ATR FTIR spectrum is measured in an ATR-FTIR spectrometer with the incident IR-beam in a first in-plane orientation to the machine direction of the laminated metal sheet or corresponding free-standing laminate layer and wherein the second ATR FTIR spectrum is measured in the ATR FTIR spectrometer after rotating the laminated metal sheet or corresponding free-standing laminate layer over an angle alpha in the plane of the laminate layer selected between 70° and 110° to a second in-plane orientation, and wherein the ATR-FTIR spectra are measured in the spectral range which includes the range of 1160 to 1520 cm-1.

13. A laminated metal sheet according to claim 11, wherein the laminate layer is predominantly or solely oriented in the machine direction or predominantly or solely perpendicular to the machine direction as a result of stretching during the production of the laminate layer in a stretching unit by exerting a stretching force only in the longitudinal or only in the transverse direction, wherein the thickness reduction of the solid laminate layer as a result of said stretching is at least 50%.

14. A laminated metal sheet according to claim 11, wherein the adhesion layer (A) i. contains or comprises a copolyester having 5-15 wt. % ethylene-isophthalate units, 80-95 wt. % ethylene-terephthalate units and 0-5 wt. % other components, ii. or contains or comprises 60-100 wt. % of a non-crystallisable copolyester, 0-40 wt. % of a crystallisable polyester or copolyester or a blend thereof and 0-10 wt. % other components, while the main polymer resin used in the one or multiple of additional top layers is poly(ethylene terephthalate) having at least 90% ethylene-terephthalate units, and wherein the adhesion layer (A) and the bulk layer (B) optionally each contain(s) additives, and wherein the bulk layer (B) optionally further contains colouring agents, dyes, toners or pigment particles.

15. A method of use of the laminated metal sheet according to claim 12, comprising making a seamless container body by drawing from the laminated metal sheet a cup having an end wall and a side wall upstanding from the periphery of the end wall wherein at least one side of the cup is covered by the laminate layer, or for making a can lid or a can end.

16. The method according to claim 1, wherein the adhesion layer (A) and the bulk layer (B) each contain(s) additives selected from slip additives and anti-block particles.

17. The method according to claim 1, wherein the adhesion layer that contains or comprises 60-100 wt. % of a non-crystallisable copolyester, 0-40 wt. % of a crystallisable polyester or copolyester or a blend thereof comprises polyethylene-terephthalate.

18. The method according to claim 9, wherein the thickness reduction of the solid laminate layer as a result of said stretching is at least 50%.

19. The method according to claim 1, wherein the metal sheet is a steel selected from uncoated cold-rolled steel, tinplate, ECCS (aka TFS), TCCT, galvanised steel or aluminised steel.

20. The method according to claim 12, wherein D_{bulk}/D_{adh} is at least 1.50.
